(19) United States
(12) Patent Application Publication
(10) Pub. No.: US 2024/0406301 A1
(43) Pub. Date: Dec. 5, 2024

(54) HANDLE FOR A MOBILE PHONE AND A METHOD OF USE

(71) Applicant: Leonardo Castgna, Ossining, NY (US)

(72) Inventor: Leonardo Castgna, Ossining, NY (US)

(21) Appl. No.: 18/679,713

(22) Filed: May 31, 2024

Related U.S. Application Data
(60) Provisional application No. 63/469,921, filed on May 31, 2023.

(51) Int. Cl. H04M 1/02

(52) U.S. Cl. CPC H04M 1/0281

(57) ABSTRACT

A handle for a mobile phone. The handle is all in one piece and it comprises a flat end, which can be glued onto the back of a mobile phone or the back of a case that fits on the back of the mobile phone, and a grip, attached to the flat end and protruding from the flat end. A mobile phone device comprising a mobile phone, a disclosed handle or the disclosed handle and a disclosed case is provided.

### TECHNICAL FIELD

This disclosure relates to a handle for a mobile phone.

### BACKGROUND

Mobile phones are great. They are getting larger and thus not as easy to hold in one hand, especially for the elderly.

### SUMMARY

In one aspect, this disclosure provides a handle for a mobile phone. The handle is all in one piece and it comprises a flat end, which can be glued on to the back of a mobile phone of a case fitted on the back of the phone, and a grip, attached to the flat end and protruding from the flat end. In some embodiments, the flat end is quadrilateral and the grip is parallel to the long side of the flat end.

In another aspect, this disclosure provides a mobile phone device comprising a disclosed handle glued onto the back of the mobile phone or onto the back of a case that fits on the back of the mobile phone.

Numerous other aspects are provided in accordance with these and other aspects of the invention. Other features and aspects of the present invention will become more fully apparent from the following detailed description and the appended claims.

### BRIEF DESCRIPTION OF THE DRAWINGS

FIG. 1 is a view of an embodiment of the disclosed handle and a case that fits to the back of a mobile phone.

FIG. 2 is a view of an embodiment of a disclosed mobile phone.

FIG. 3 is a view of an embodiment of a disclosed mobile phone.

FIG. 4A and FIG. 4B present views of an embodiment of a disclosed retractable handle.

FIG. 5 shows an embodiment of the disclosed mobile phone hung by its handle in a car.

FIG. 6 shows an embodiment of the disclosed mobile phone hung on a shower curtain.

FIG. 7 shows an embodiment of the disclosed mobile phone hidden by papers on a desk.

FIG. 8 shows an embodiment of the disclosed mobile phone hung on the waist of a person's pants.

### DETAILED DESCRIPTION

As used herein, the word “a” or “plurality” before a noun represents one or more of the particular noun.

For the terms “for example” and “such as,” and grammatical equivalences thereof, the phrase “and without limitation” is understood to follow unless explicitly stated otherwise. As used herein, the term “about” is meant to account for variations due to experimental error. All measurements reported herein are understood to be modified by the term “about,” whether or not the term is explicitly used, unless explicitly stated otherwise. As used herein, the singular forms “a,” “an,” and “the” include plural referents unless the context clearly dictates otherwise.

All ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should be considered to include the end points 5 and 10.

It is further to be understood that the feature or features of one embodiment may generally be applied to other embodiments, even though not specifically described or illustrated in such other embodiments, unless expressly prohibited by this disclosure or the nature of the relevant embodiments. Likewise, compositions and methods described herein can include any combination of features and/or steps described herein not inconsistent with the objectives of the present disclosure. Numerous modifications and/or adaptations of the compositions and methods described herein will be readily apparent to those skilled in the art without departing from the present subject matter.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

In one aspect, this disclosure provides a handle for a mobile phone. The handle is all in one piece and it comprises a flat end, which can be glued onto the back of a mobile phone, and a grip, attached to the flat end and protruding from the flat end. The flat end is adapted to be glued onto the back of a mobile phone or a case fitted onto back of a mobile phone. In some embodiments, the flat end is quadrilateral; and in some embodiments, the grip is either parallel or perpendicular to the long side of the flat end.

In some embodiments, the handle is retractable and further comprises hinges between the flat end and the grip. The hinges are retractable and allow the grip and the flat end to be open or closed. When the hinges are in a closed position, they lock the handle in place and the grip and the flat end are flush against each other. When the hinges are in an open position, they allow the grip to be open and not retracted against the flat end. The flat end can be glued onto the mobile phone or it can be glued onto a case for the mobile phone, the case fitting snugly on the back of the phone.

The handle can be any size. In some embodiments, the grip is ½″ to ¼″ thick.

In another aspect, this disclosure provides a mobile phone device comprising a mobile phone and a disclosed handle glued onto the back of the mobile phone. In some embodiments, the mobile phone device further comprises a case fitted on the back of the mobile phone; in some embodiments, the case fits on the back of the mobile phone snugly. The handle can be glued onto the mobile phone or the case with, for example and without limitation, a glue sticker. In some embodiments, the handle allows the mobile phone device to stand both ways, both on the long side or short side of the device.

Methods of making the disclosed handle are known in the art. The handle can be made of any suitable materials. In some embodiments, the handle is made of plastic, such as hard plastic. The case can be made of any suitable material, such as plastic, and be of any suitable size. Methods of making the case is also known in the art. The mobile phone is any available mobile phone.

The disclosed handle and the disclosed phone have many advantages, including:
never press unintentionally the volume and On/Off buttons on the side.
Standing or laying on the side a user can have a video call, enjoy a movie, watch a show while the user is cooking or reading a recipe.
Will never fall from the user's hand. As phone screens get larger the phone is not always easy to hold in one hand.
It can be hung anywhere and does not get the phone wet when answering it from the shower.
The user only needs to dry the tip of the index finger.
The phone can also hang on the sun visor while driving and to receive a call, just slide it and press the speaker.
Does not go all the way inside your pocket or airplane pockets.
Stays up or sideways on any desk or counter top.
One can find it quickly on a busy desk.
One can carry it in your belt.
If can be retractable.
It's easier to navigate the Web and send a text message for people who use one hand.
Dirty hands working or in the kitchen, only the handle gets dirty when one answers it and one only have to clean the tip of the index finger.
The elderly will remember how they used to hold a telephone 30 years ago and they will find it very easy to use.

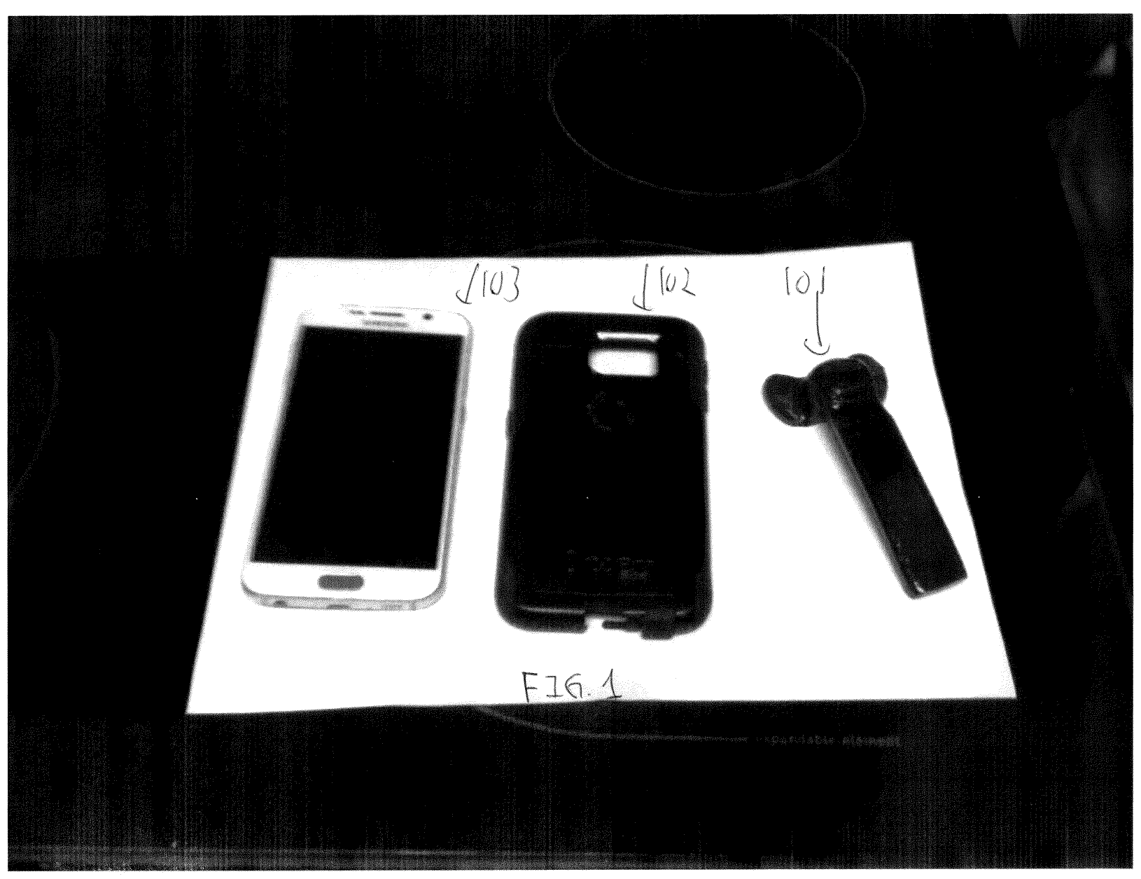

These and other embodiments of the invention are described below with reference to FIG. 1-FIG. 8.

An embodiment of a disclosed handle 101, a case 102, and a mobile phone 103 are shown in FIG. 1.

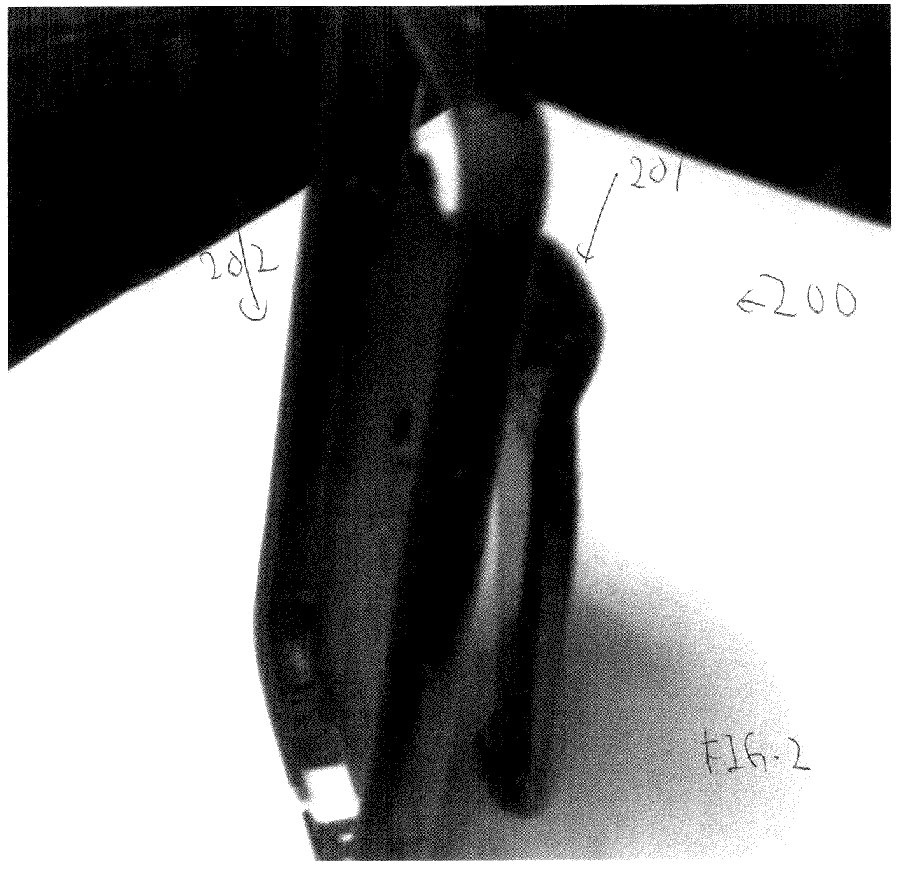

An embodiment of a disclosed handle 201, glued on a case 202, are shown in FIG. 2. 200 is handle 201 and case 202 together.

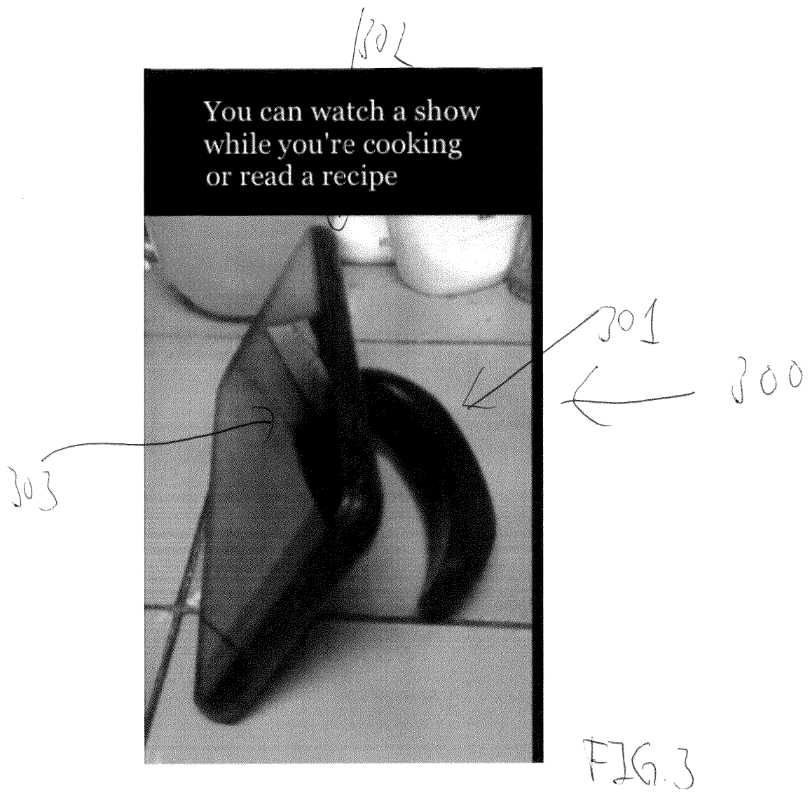

An embodiment of a disclosed mobile phone device 300 is shown in FIG. 3. Device 300 comprises handle 301 and case 302.

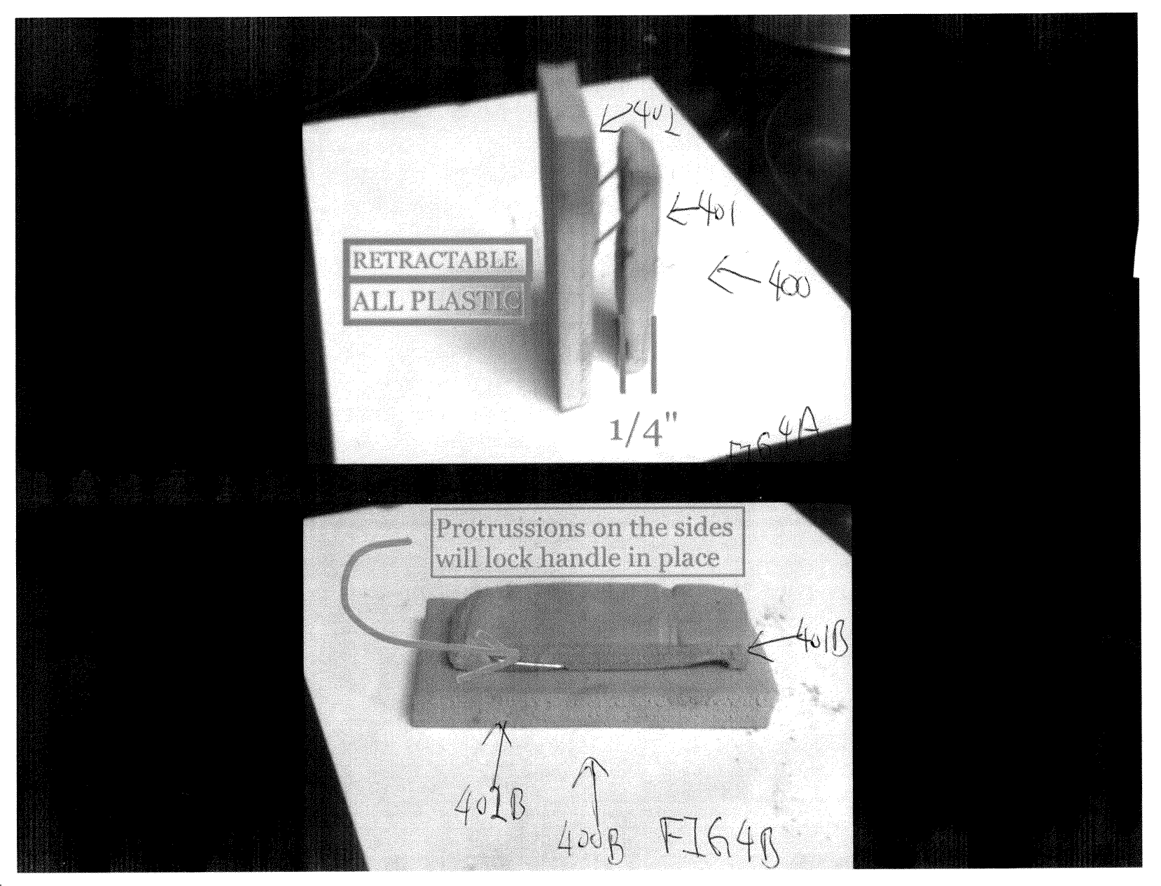

FIG. 4A shows an embodiment 400 of a retractable handle 401 on a flat end 402 with hinges 403 and 404; the handle 401 is in an open position. FIG. 4B shows an embodiment 400B of a retractable handle 401B on a flat end 402B with hinges 403B and 404B; the handle 401B is in a closed position.

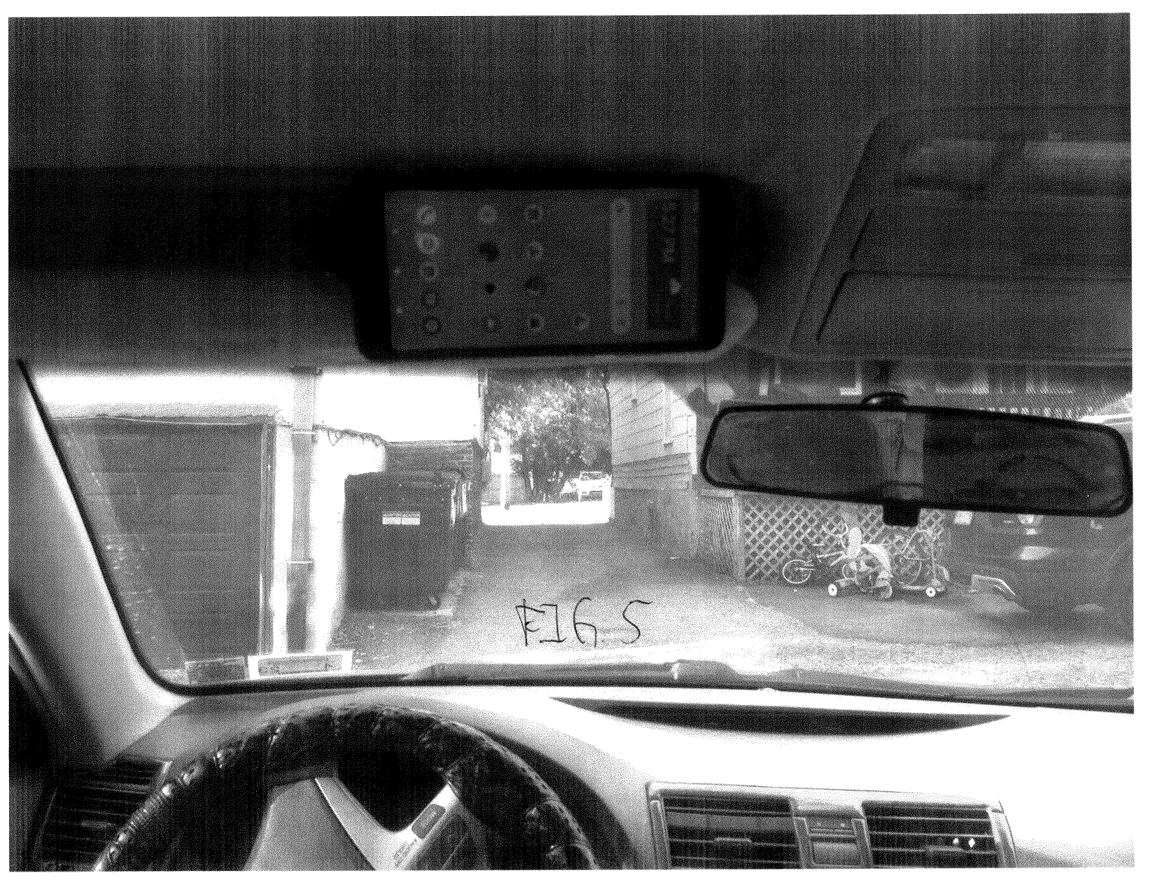

FIG. 5 shows an embodiment of a disclosed mobile phone device hung by its handle in a car, on the sun visor.

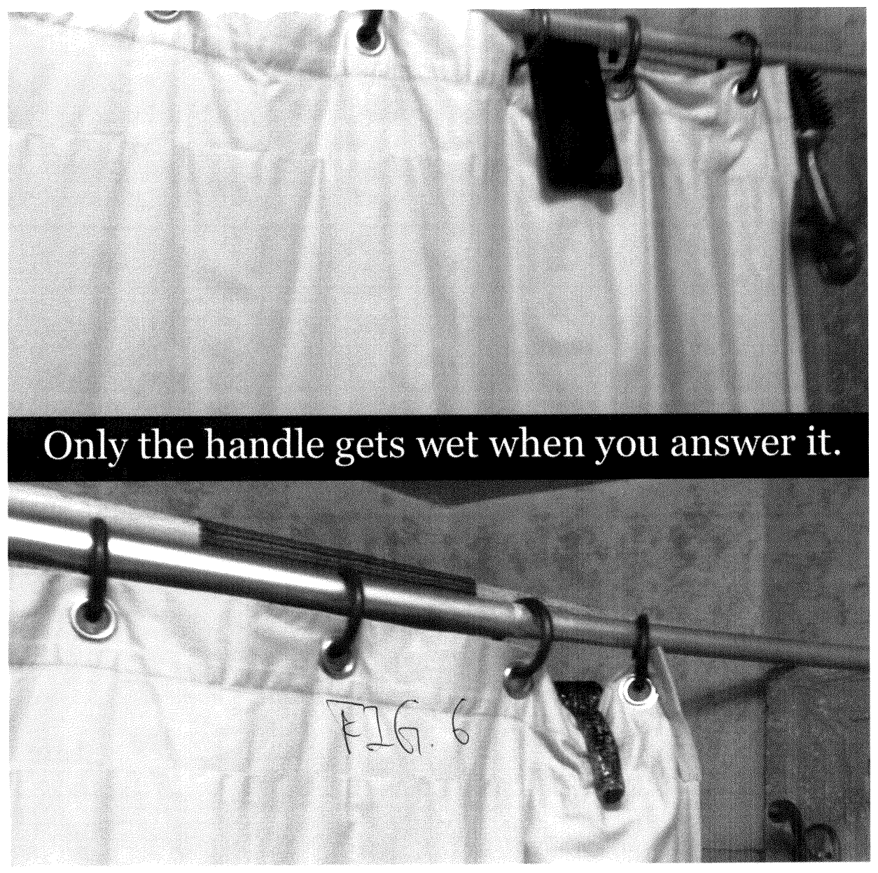

FIG. 6 shows an embodiment of a disclosed mobile phone device hung by its handle on a shower curtain.

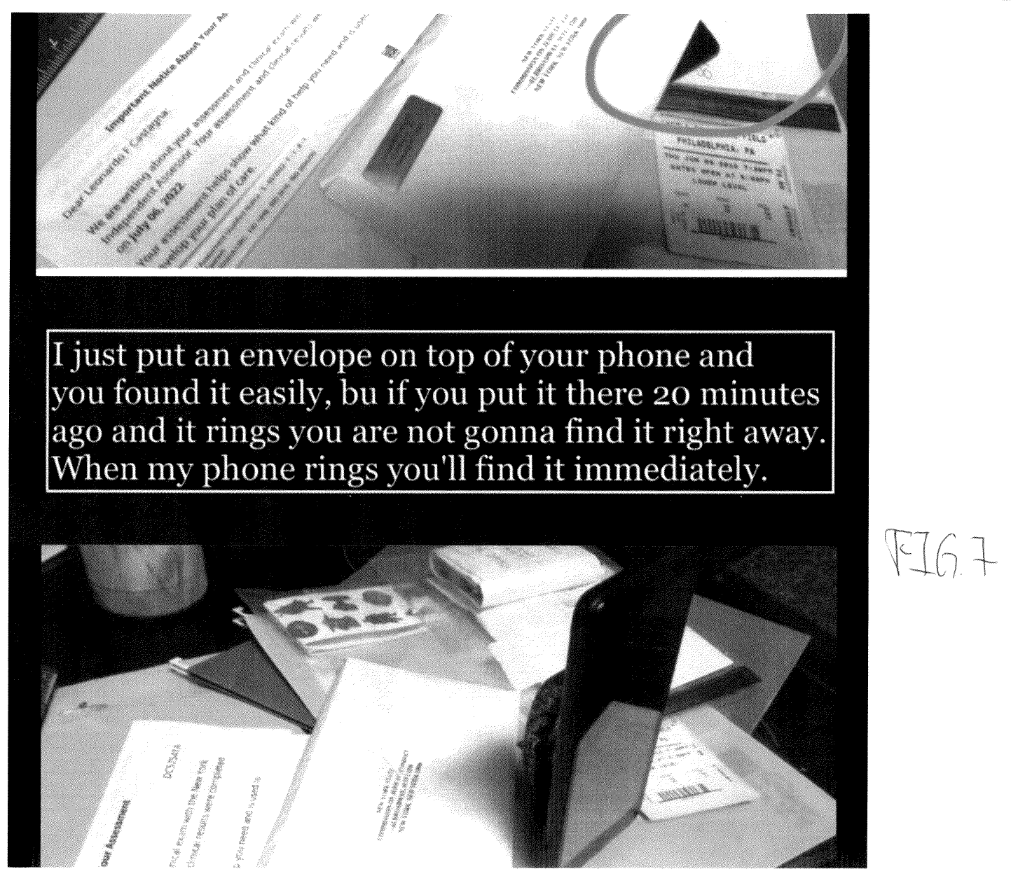

FIG. 7 shows an embodiment of a disclosed mobile phone device hidden by papers on a desk.

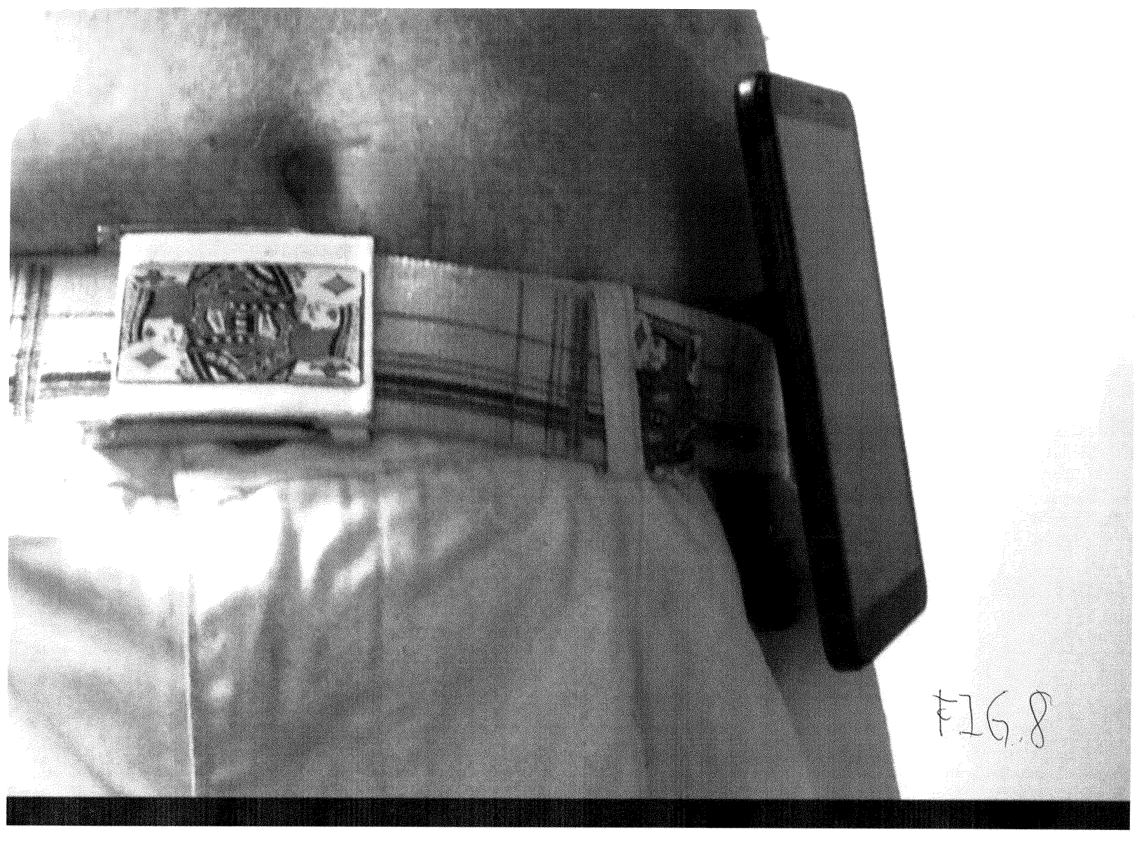

FIG. 8 shows an embodiment of a disclosed mobile phone device hung on the waist of a person's pants by its handle.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the appended claims. Thus, while only certain features of the invention have been illustrated and described, many modifications and changes will occur to those skilled in the art. It is therefore to be understood that the appended claims are intended to cover all such modifications and changes as fall within the true spirit of the invention.

What is claimed is:

1. An all-in-one piece handle for a mobile phone comprising and a flat end and a grip attached to the flat end and protruding from the flat end, wherein the flat end is adapted to be glued onto back of a mobile phone or a case fitted onto back of a mobile phone.

2. The handle of claim 1, wherein the flat end is quadrilateral and the grip is parallel or perpendicular to the long side of the flat end.

3. The handle of claim 1, wherein the handle is retractable and further comprises hinges between the flat end and the grip; wherein when the hinges are in a closed position, they lock the handle in place with the flat end and the grip flush against each other; and wherein when the hinges are in an open position they allow the grip to be open and not retracted against the flat end.

4. The handle of claim 1, wherein the grip is ½″ to ¼″ thick.

5. The handle of claim 1, wherein the handle is made of plastic.

6. A mobile phone device comprising a mobile phone and a handle of claim 1, wherein the handle is glued onto the back of the mobile phone.

7. A mobile phone device comprising a mobile phone and a handle of claim 1, further comprising a case that fits onto the back of the mobile phone, wherein the handle is glued onto the back of the case.

8. The mobile phone device of claim 7, wherein the case fits on the back of the phone snugly.
